(19) United States
(12) Patent Application Publication
(10) Pub. No.: US 2025/0178373 A1
(43) Pub. Date: Jun. 5, 2025

(54) Picture Book Kit and Method of Assembly

(71) Applicant: Erin Sparler, Marysville, PA (US)

(72) Inventor: Erin Sparler, Marysville, PA (US)

(21) Appl. No.: 18/964,033

(22) Filed: Nov. 29, 2024

Related U.S. Application Data
(60) Provisional application No. 63/605,432, filed on Dec. 1, 2023.

(51) Int. Cl. B42D 1/00; B42C 19/02

(52) U.S. Cl. CPC B42D 1/004; B42C 19/02

(57) ABSTRACT

A dynamic tunnel book assembly and the associated method of creating the tunnel book assembly from a component kit. The tunnel book assembly has page substrates and a rear cover. Each of the page substrates includes a hole. When the page substrates are stacked into a book, the holes in the page substrates at least partially overlap and form a tunnel. A plurality of secondary elements are provided. The secondary elements attach to the page substrates with fasteners that allow the secondary elements to pivot. Furthermore, each of the secondary elements is an assembly of pieces. At least some of the pieces in the assembly are selectively positionable. This enables at least some of the pieces to be selectively extended into the tunnel. The page substrates and the pieces of the secondary elements are customed colored prior to assembly.

### RELATED APPLICATIONS

This application claims the benefit of U.S. Provisional Patent Application No. 63/605,432, filed Dec. 1, 2023.

### BACKGROUND OF THE INVENTION

### 1. Field of the Invention

The present invention relates to picture book kits where a person is free to color and decorate the pages of the book prior to assembly. The present invention also relates to the structure of the book and the manner in which secondary elements are attached to the pages of the book.

### 2. Background Art

In the book publishing industry, tunnel book is the name given to a book that has a hole extending through the cover and the pages of the book so that an image on the inside of the back cover can be seen through the structure of the book. Often the hole opening on each of the pages increases in size so that more of the back cover image can been seen each time a page is turned. Tunnel books were initially called peephole books and became popular during the Victorian Age in the late 1800's. Tunnel books were some of the first books that provided three-dimensional details to a book and are the precursors to later pop-up books.

Tunnel books have changed very little since their inception. In a modern tunnel book, there is a hole in the cover of the book and on each page of the book. The holes often decrease in size from front cover to last page. Although the book does have three-dimensional features, the book remains static. Once the book is opened and viewed, the book quickly loses its novelty.

The present invention is a dynamic tunnel book and the associated method for making the dynamic tunnel book. As will be explained, the present invention tunnel book enables the cover and the pages of the tunnel book to be customized by a reader. The present invention also enables features on the cover and the pages to be altered each time the book is read. As such, a dynamic experience is produced that makes the tunnel book far more interesting to the reader. The details of the improved tunnel book are described and claimed below.

### SUMMARY OF THE INVENTION

The present invention is a dynamic tunnel book assembly and the associated method of creating the tunnel book assembly from a component kit. The tunnel book assembly has a plurality of page substrates and a rear cover. Each of the page substrates includes a hole. When the page substrates are stacked into a book, the holes in the page substrates at least partially overlap and form a tunnel. The tunnel in the tunnel book assembly ends at the rear cover, wherein the rear cover is observable through the tunnel.

A plurality of secondary elements are provided that selectively attach to the page substrates. The secondary elements attach to the page substrates with fasteners that allow certain features of the secondary elements to articulate Accordingly, at least some of the pieces in the assembly are selectively positionable relative to the other pieces. Depending upon placement, this enables at least some of the pieces to be selectively extended into the tunnel and outside the boundaries of the pages.

The page substrates and the pieces of the secondary elements are custom-colored prior to assembly. Once colored, the pieces of the secondary elements are assembled, and the secondary elements are attached to the page substrates. This creates page constructs. The page constructs are then assembled into the tunnel book assembly. The positions of the secondary elements assembled into the tunnel book assembly can be altered at will, therein creating a dynamic book assembly that appears differently every time it is read.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 shows an exemplary embodiment of a tunnel book assembly in a fully assembled condition;

FIG. 2 shows page substrates used in the formation of the exemplary embodiment of FIG. 1;

FIG. 3 shows a perforated page containing cut-out pieces for making secondary elements that attach to the page substrates;

FIG. 4 shows the components of a kit that are packaged together to make the tunnel book assembly of FIG. 1; and

FIG. 5 shows an alternate embodiment for a perforated page that contains cut-out pieces for making secondary elements.

### DETAILED DESCRIPTION OF THE DRAWINGS

Although the present invention tunnel book assembly and methodology can be embodied in many ways, only two exemplary embodiments are illustrated. The exemplary embodiments are being shown for the purposes of explanation and description. The exemplary embodiments are selected in order to set forth some of the best modes contemplated for the invention. The illustrated embodiments, however, are merely exemplary and should not be considered a limitation when interpreting the scope of the appended claims.

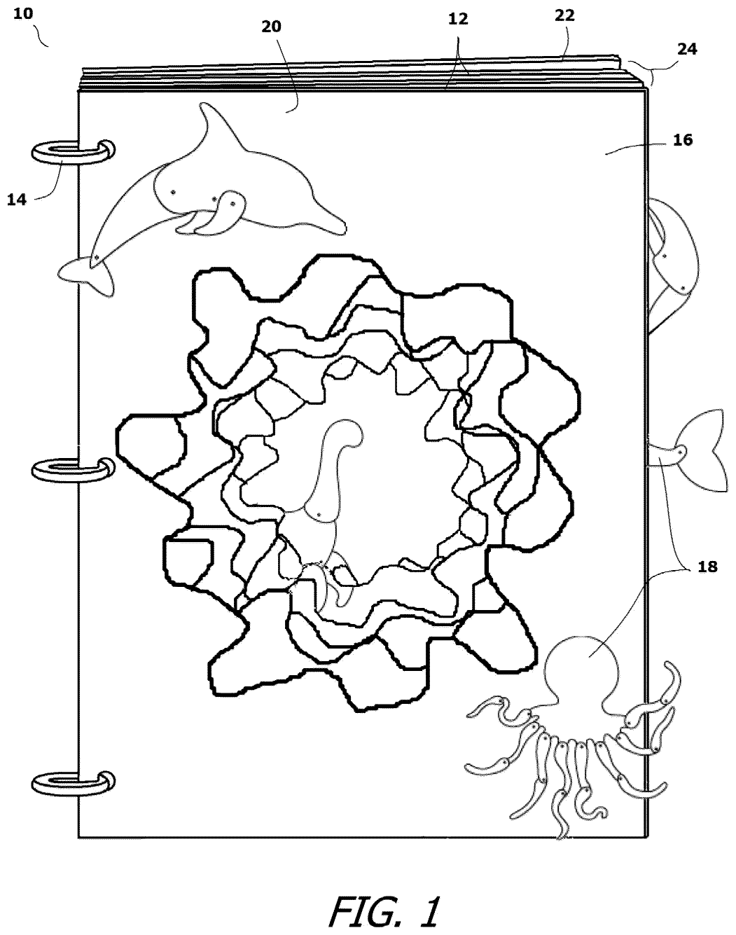

Referring to FIG. 1, a tunnel book assembly 10 is shown. The tunnel book assembly 10 has a plurality of page constructs 12 that can be bound together using commercial page binders 14. The page binders 14 can be rings, clips, split brads, or any other fastener system that is used to bind loose pages together into the form of a book. The number of page constructs 12 in the tunnel book assembly 10 can vary, but is preferably between four and twelve.

Each of the page constructs 12 includes a page substrate 16. Each of the page substrates 16 in the tunnel book assembly 10 are generally the same size. Secondary elements 18 are selectively attached to one or more of the page substrates 16 to produce more complex page constructs 12. The secondary elements 18 have features that can extend beyond the boundaries of the page substrates 16, therein providing the overall page constructs 12 with unusual shapes.

In the tunnel book assembly 10, the page substrates 16 include a first page substrate 20, a last page substrate 22, and subsequent page substrates 24. The first page substrate 20 serves as the front cover of the tunnel book assembly 10. The last page substrate 22 serves as the rear cover of the tunnel book assembly 10. The last page substrate 22 is solid. The first page substrate 20 and the subsequent page substrates 24 prior to the last page substrate 22 all contain view holes.

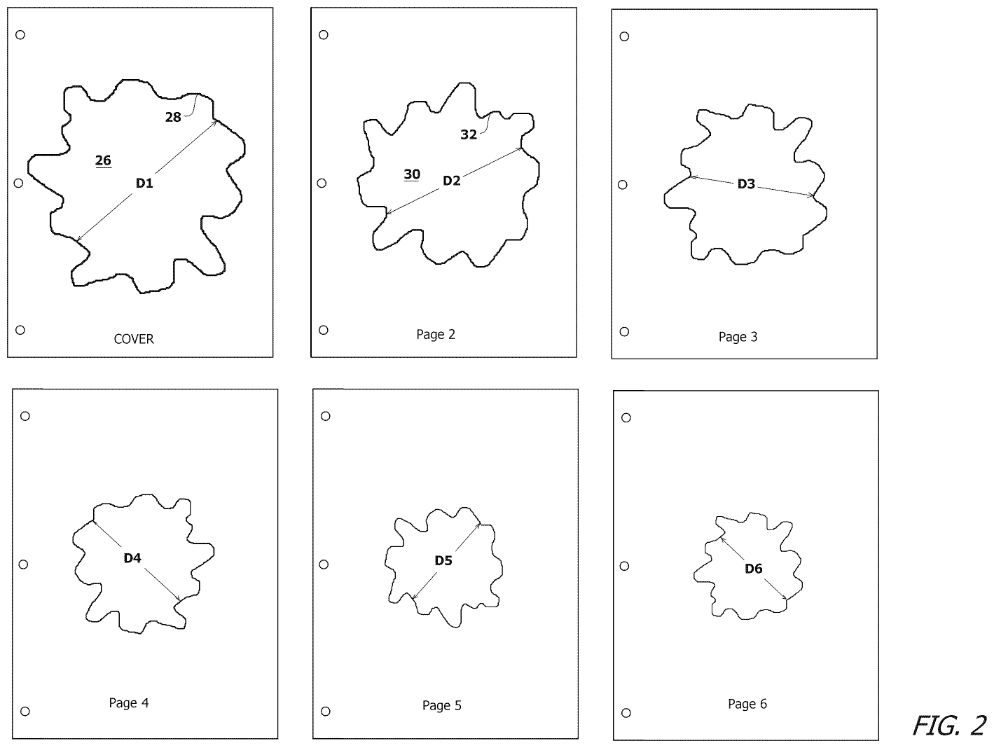

Referring to FIG. 2 in conjunction with FIG. 1, it can be seen that the first page substrate 20 has a large first view hole 26 formed at or near its center. The first view hole 26 preferably has a chaotic peripheral edge 28 in a first pattern. The first view hole 26 on the first page substrate 20 has an average diameter D1. The chaotic peripheral edge 28 of the first view hole 26 can be shaped to match a theme. For example, if the overall theme of the tunnel book assembly 10 is that of an ocean or pond, the chaotic peripheral edge 28 can include the shapes of splash drops or waves. If the overall theme of the tunnel book assembly 10 is that of a garden or field, the chaotic peripheral edge 28 can include the shapes of leaves or peddles. The overall shape of the view holes are based on the still frames of traditional animation techniques for special effects. The selection of the shapes for the view holes are based on the theme of the book. For example, a book with an ocean or pond theme would have view holes that form a tunnel in the shape of ripples created in water from a rock or an animal jumping into the water and the subsequent decrease in the ripple effect. For a book with a dragon theme, the view holes can form a tunnel with fire flickers and the like.

The first page substrate 20 is the cover of the tunnel book assembly 10. Each of the subsequent page substrates 24 has a progressively smaller view hole 30 formed along a common progression line 31. Each of the subsequent smaller view holes 30 also has a chaotic peripheral edge 32 that preferably shares the same theme as does the first view hole 26. However, different themes can be used on subsequent page substrates 24 if the theme of the story being depicted changes. For example, if different page substrates contain text regarding a house made of straw, a house made of sticks and a house made of bricks, the chaotic peripheral edges 32 on those pages can have themes of straw, sticks and bricks, respectively. Regardless of the selected themes, the average diameter (D2, D3, D4, D5, D6) of the subsequent smaller view holes 30 preferably decreases between five percent and twenty percent from that of the previous page substrate.

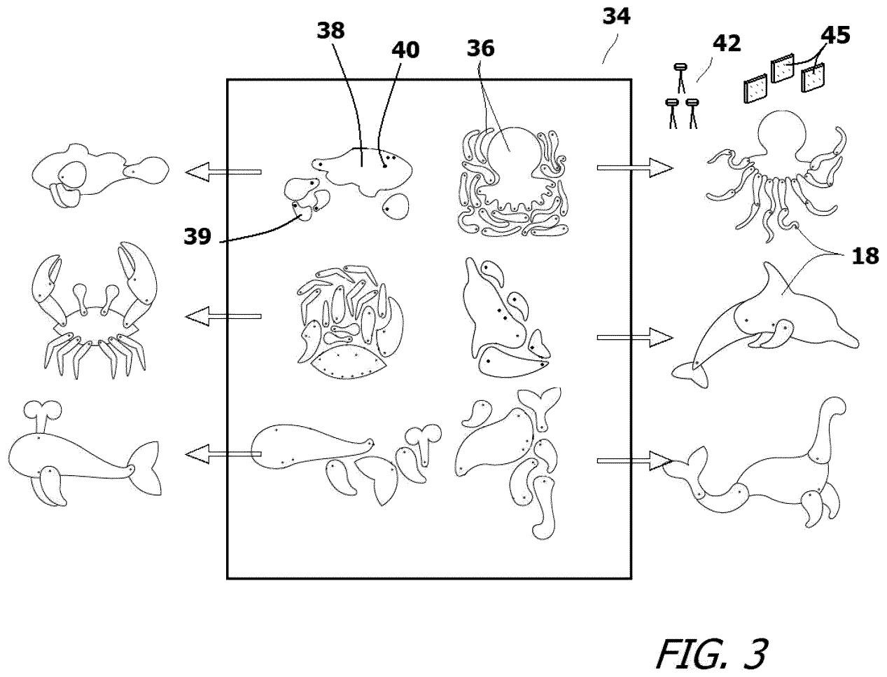

Referring to FIG. 3 in conjunction with FIG. 1, it will be understood that the page substrates 16 are packaged with perforated character sheets 34. The character sheets 34 contains the components needed to assemble the secondary elements 18 prior to the secondary elements 18 being attached to the page substrates 16. Each perforated character sheet 34 contain one or more groupings of related pieces 36. The perforated character sheets 34 are preferably made from the same material as the page substrates. Accordingly, the perforated character sheets 34 and the groupings of related pieces 36 contained on each perforated character sheet 34 can be made of paper, paperboard, cardboard, chipboard, plastic, or thin sheets of plywood. The pieces 36 in each grouping are designed to create a specific secondary element 18 when assembled. The pieces 36 in each grouping typically form an animal or insect. However, depending on the overall theme of the tunnel book assembly 10, the pieces can create plants or manufactured objects, such as vehicles or spaceships. If grouping of pieces 36 forms an animal or insect, there are typically at least one body piece 38 and appendage pieces 39 for legs, fins, tails, necks, tentacles, and the like.

For each related group of pieces 36, the pieces 36 assemble into a secondary element 18. Each of the pieces 36 contains pivot holes 40 that are sized to receive fasteners 42. The fasteners 42 are preferably split post fasteners, typically referred to as bards or mini-brads, that both join pieces together and then act as a pivot post to enable the pieces 36 to rotate about the fastener 42 relative to each other. The double-side tape 45 or similar adhesive elements 42 are used to connect the secondary elements 18 to the page substrates 16. This provides the secondary elements 18 with the ability to be selectively placed anywhere on a page substrate. Typically, the body of the secondary element 18 is adhered to the page substrate 16. The other pieces 36 forming the secondary element 18 can all be moved relative to the body and one another. In this manner, each of the secondary elements 18 can have pieces 36 that are alterable in position by the reader of the tunnel book assembly 10.

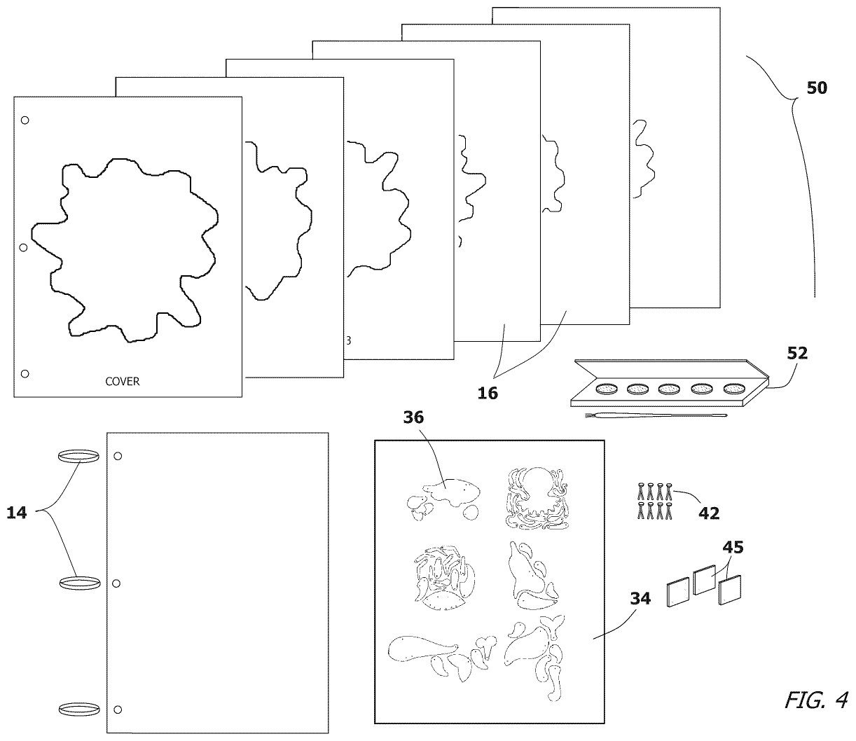

Referring to FIG. 4 in conjunction with FIG. 1, it will be understood that the tunnel book assembly 10 can be sold as a kit 50. The kit contains page substrates 16, perforated character sheets 34, page binders 14, tape 45, fasteners 42 and marking material 52. The marking material 52 can be a tray of paints, as is shown. However, the tray of paints can be substituted with a collection of colored markers, colored pencils, crayons, water brush pens, water crayons and the like. The page substrates 16 and the perforated character sheets 34 are preferably made of white paperboard, chip boards, cardboard, or similar substrate material. The page substrates 16 and the perforated character sheets 34 can be custom colored by the reader either before or after assembly. Optional text of a story and/or guidelines for images can be printed on some of the page substrates 16. Otherwise all surfaces can be blank to be filled in by the user.

Once the kit 50 is purchased and unpackaged, the reader custom colors the various page substrates. The reader also custom colors all the pieces 36 on the perforated character sheets 34. The pieces 36 are removed from the perforated character sheets 34 and assembled into the secondary elements 18. The secondary elements 18 are attached to one or more of the page substrates 16 to form page constructs 12. The page constructs 12 are then assembled into the overall tunnel book assembly 10. Each time the tunnel book assembly 10 is opened, the shapes of the secondary elements 18 can be changed by manipulating the different pieces 36 that make up the secondary elements 18. Looking at the front of the tunnel book assembly 10, the various holes 26, 30 form a tapered tunnel 54 that enables parts of all the page constructs 12 in the tunnel book assembly 10 to be viewed simultaneously. In this manner, parts of the secondary elements 18 that extend into the tapered tunnel 54 from the different page constructs 12 can all be seen. This provides three-dimensional depth to the overall tunnel book assembly 10.

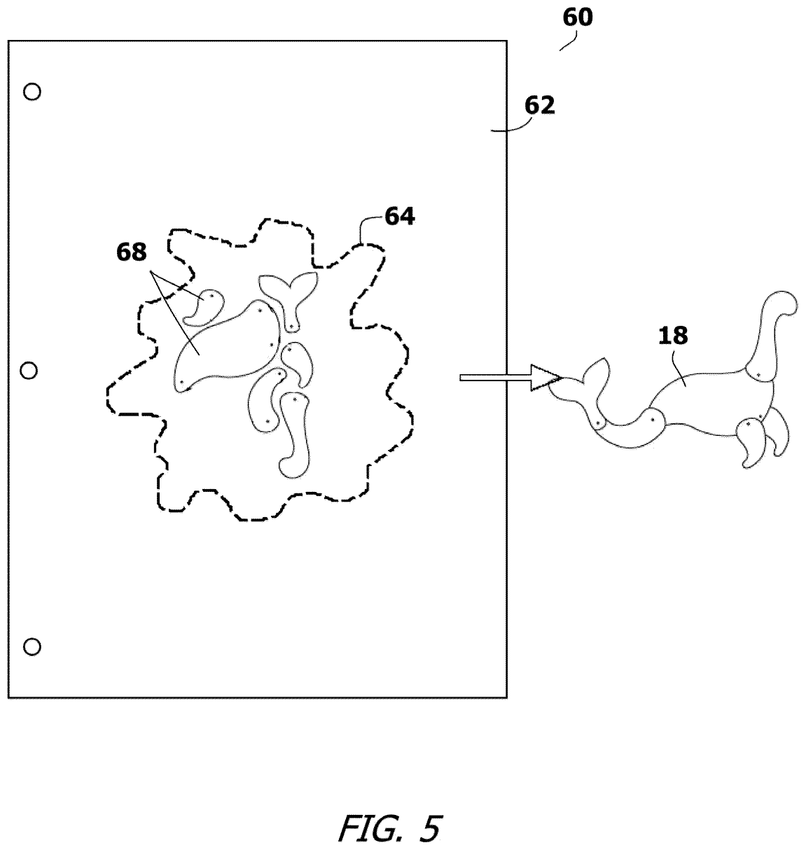

In the first embodiment of the tunnel book assembly 10, the page substrates 16 and the perforated character sheets 34 are separate and distinct. It will be understood that these elements can be combined. Referring to FIG. 5, a compound substrate 60 is shown. The compound substrate 60 can be utilized as both a page substrate and a perforated substrate. The compound substrate 60 has a main section 62 that contains a hole cut-out section 64. Once the hole cut-out section 64 is removed, the main section 62 can be used as a new page.

The hole cut-out section 64 that has been removed contains smaller cut-out pieces 68 that can be assembled into secondary elements 18. The secondary elements 18 can then be attached to the main section 62 or to another page of the tunnel book assembly.

It will be understood that the embodiments of the present invention that are illustrated and described are merely exemplary and that a person skilled in the art can make many variations to the embodiments. All such embodiments are intended to be included within the scope of the present invention as defined by the appended claims.

What is claims is:

1. A tunnel book assembly having
a plurality of page substrates that each contain a hole, wherein said hole of each of said plurality of page substrates at least partially overlap and form a tunnel in said tunnel book assembly when said plurality of page substrates are stacked; and
a plurality of secondary elements that are selectively attachable to any of said plurality of page substrates with pivot joints, wherein each of plurality of secondary elements is an assembly of pieces, and wherein at least some of said pieces in said assembly of pieces are selectively positionable relative other pieces in said assembly of pieces and at least some of said pieces can be selectively extended into said tunnel.

2. The assembly according to claim 1, further including a solid rear cover that stacks with said plurality of page substrates, wherein said tunnel in said tunnel book assembly ends at said rear cover and said rear cover is observable through said tunnel.

3. The assembly according to claim 2, wherein each said hole in each of said plurality of page substrates has a different average diameter, therein causing said tunnel to taper as said tunnel progresses toward said rear cover.

4. The assembly according to claim 2, wherein each said hole in each of said plurality of page substrates has a peripheral edge with shaped features that are visible in said tunnel.

5. The assembly according to claim 2, wherein said plurality of secondary elements are flat paperboard constructions in a shape selected from a group consisting of animals, insects, plants, and manufactured objects.

6. The assembly according to claim 5, wherein said assembly of pieces forming each of said secondary elements is joined together at pivot points that enable each of said pieces to move independently.

7. A method of creating a tunnel book assembly, comprising the steps of:
providing a plurality of page substrates that each contain a hole;
providing a plurality of secondary elements wherein each of plurality of secondary elements is a flat paperboard construction in a shape selected from a group consisting of animals, insects, plants, and manufactured objects;
attaching said plurality of secondary elements to said plurality of page substrates;
binding said plurality of page substrates together, wherein each said hole in said plurality of page substrates overlap and form a tunnel, and wherein at least some parts of said plurality of secondary elements extend into said tunnel.

8. The method according to claim 7, further including binding a solid rear cover to said plurality of page substrates, wherein said tunnel in said tunnel book assembly ends at said rear cover and said rear cover is observable through said tunnel.

9. The method according to claim 7, wherein providing a plurality of secondary elements includes providing said plurality of secondary elements in a blank condition and custom decorating each of said plurality of secondary elements.

10. The method according to claim 9, wherein providing a plurality of page substrates includes providing said plurality of page substrates in a blank condition and custom decorating each of said plurality of page substrates prior to binding.

11. The method according to claim 10, further including providing marking material for custom decorating said plurality of secondary elements and said plurality of page substrates.

12. The method according to claim 11, wherein said marking material is selected from a group consisting of paint, markers, pencils, and crayons.

13. The method according to claim 11, wherein attaching said plurality of secondary elements to said plurality of page substrates includes attaching sections of said plurality of secondary elements to said plurality of page substrates with adhesive fasteners.

14. The method according to claim 7, wherein binding said plurality of page substrates together includes joining said plurality of page substrates together with ring clips.
